(19) United States
(12) Patent Application Publication
(10) Pub. No.: US 2010/0157466 A1
(43) Pub. Date: Jun. 24, 2010

(54) MAGNETIC DISK DEVICE, CONTROL DEVICE AND CONTROL METHOD

(75) Inventor: Hiroaki Inoue, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Toshiba Storage Device Corporation, Tokyo (JP)

(21) Appl. No.: 12/642,524

(22) Filed: Dec. 18, 2009

(30) Foreign Application Priority Data
Dec. 22, 2008 (JP) 2008-324944

(51) Int. Cl. G11B 21/02

(52) U.S. Cl. 360/75; G9B/21.003

(57) ABSTRACT

According to one embodiment, a magnetic disk device, includes: a magnetic disk; a magnetic head; a writing module configured to write data to a predetermined first track in at least one of the areas by the magnetic head; a reading module configured to read, by using the magnetic head, data of a second track in the at least one of the areas; a first judging module configured to judge whether there is an error in the data read by the reading module; and a first recording module configured to associate and record in a storage module, when the first judging module judges that there is the error in the data of the second track, the at least one of the areas and the number of writing the data to the first track by the writing module.

### CROSS-REFERENCE TO RELATED APPLICATIONS

This application is based upon and claims the benefit of priority from Japanese Patent Application No. 2008-324944, filed Dec. 22, 2008, the entire contents of which are incorporated herein by reference.

### BACKGROUND

1. Field

One embodiment of the invention relates to technology to deal with a side erase phenomenon in a magnetic disk device.

2. Description of the Related Art

Conventionally, in the magnetic disk device, the side erase phenomenon in which, when data is repeatedly written to a same site on a magnetic disk, data of a track adjacent to the written site is erased by a leakage magnetic field of the magnetic head is known. As a method of preventing the side erase phenomenon, technology to enhance magnetic by rewriting the data to tracks on both sides of the site to which the writing is repeatedly performed is known (for example, see Japanese Patent Application Publication (KOKAI) No. 2004-273060).

In the above-described technology, however, it is necessary to read the data and write again in order to rewrite the data to the tracks on the both sides of the site to which the data is repeatedly written. A condition in which the side erase phenomenon occurs differs according to an individual head and an individual magnetic disk. Therefore, according to the above-described technology, the data might be rewritten even in the track in which the side erase phenomenon does not occur. That is to say, performance of the magnetic disk device might be deteriorated due to excessive rewriting.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a magnetic disk device connected to a higher-level device according to an embodiment of the invention;

FIG. 2 is an exemplary view of a plurality of test areas in the embodiment;

FIG. 3 is an exemplary view of a plurality of tracks in a test area in the embodiment;

FIG. 4 is an exemplary threshold table in an initial state in the embodiment;

FIG. 5 is an exemplary block diagram of the magnetic disk device in the embodiment;

FIG. 6 is an exemplary flowchart of set processing in the embodiment;

FIG. 7 is an exemplary flowchart of test processing in the embodiment;

FIG. 8 is an exemplary flowchart of the test processing in the embodiment; and

FIG. 9 is an exemplary threshold table after the test processing in the embodiment.

### DETAILED DESCRIPTION

Various embodiments according to the invention will be described hereinafter with reference to the accompanying drawings. In general, according to one embodiment of the invention, a magnetic disk device, comprises: a magnetic disk configured to be provided with predetermined areas at a plurality of positions, each of the areas having a plurality of consecutive tracks; a magnetic head configured to record data in the magnetic disk and read the recorded data; a writing module configured to write data to a predetermined first track in at least one of the areas by the magnetic head; a reading module configured to read, by using the magnetic head, data of a second track in the at least one of the areas; a first judging module configured to judge whether there is an error in the data read by the reading module; and a first recording module configured to associate and record in a storage module, when the first judging module judges that there is the error in the data of the second track, the at least one of the areas and the number of writing the data to the first track by the writing module.

According to another embodiment of the invention, A control device of a magnetic disk device for recording, by a magnetic head, data in a magnetic disk provided with a predetermined areas at a plurality of positions, each of the areas having a plurality of consecutive tracks, the control device comprises: a writing module configured to write data to a predetermined first track in at least one of areas by the magnetic head; a reading module configured to read, by using the magnetic head, data of a second track in the at least one of the areas; a first judging module configured to judge whether there is an error in the data read by the reading module; and a first recording module configured to associate and record in a storage module, when the first judging module judges that there is the error in the data of the second track, the at least one of the areas and the number of writing the data to the first track by the writing module.

According to still another embodiment of the invention, a control method of a magnetic disk device for recording, by a magnetic head, data in a magnetic disk provided with a predetermined areas at a plurality of positions, each of the areas having a plurality of consecutive tracks, the control method comprises: writing data to a predetermined first track in at least one of areas by the magnetic head; reading, by using the magnetic head, data of a second track in the at least one of the areas; first judging whether there is an error in the data read by the reading; and first associating and recording in a storage module, when the judging judges that there is the error in the second data, the at least one of the areas and the number of writing the data to the first track by the writing.

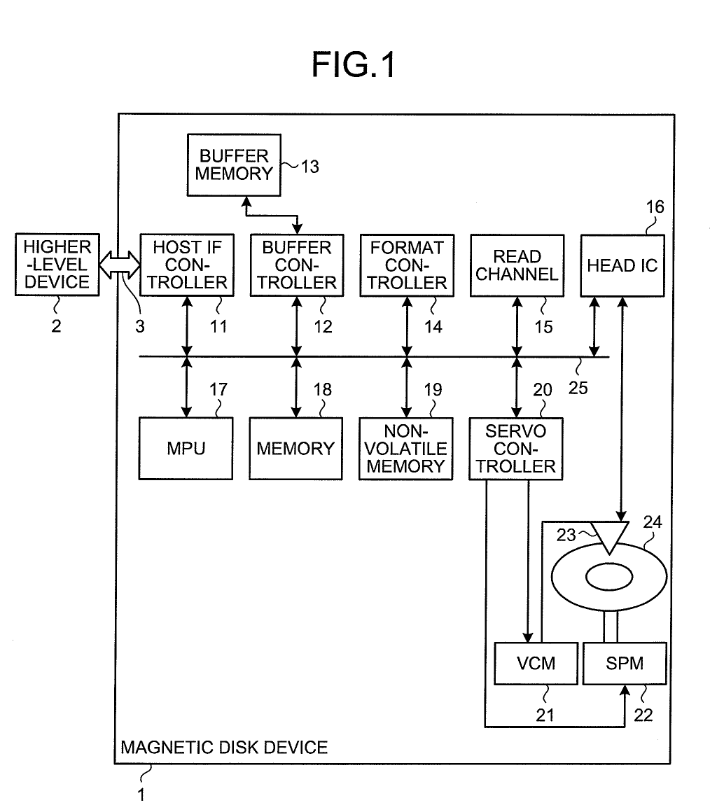

First, a hardware configuration of a magnetic disk device according to one embodiment is described. FIG. 1 is a block diagram illustrating a hardware configuration of a magnetic disk device 1 connected to the higher-level device 2.

As illustrated in FIG. 1, the higher-level device 2 as a host and the magnetic disk device 1 are connected to each other through a host interface (IF) 3. The higher-level device 2 is a computer comprising the magnetic disk device 1 as a storage device for issuing a command to the magnetic disk device 1 when reading and writing data.

The magnetic disk device 1 comprises a host interface (IF) controller 11, a buffer controller 12, a buffer memory 13, a format controller 14, a read channel 15, a head integrated circuit (IC) 16, a microprocessor unit (MPU) 17, a memory 18, a nonvolatile memory 19, a servo controller 20, a voice coil motor (VCM) 21, a spindle motor (SPM) 22, a read/write head (magnetic head) 23, a magnetic disk 24, a bus 25, and the host IF 3.

The host IF 3 performs communication for transmitting and receiving the data and the command between the magnetic disk device 1 and the higher-level device 2. The host IF controller 11 controls the data and the command to the higher-level device 2 transmitted through the host IF 3. The host IF controller 11 controls the data and the command transmitted from the higher-level device 2 and received by the host IF 3. The buffer controller 12 controls writing and reading of the data stored in the buffer memory 13. The buffer memory 13 temporarily stores the data written to the magnetic disk 24 and the data read from the magnetic disk 24. The format controller 14 generates a writing format of the data written to the magnetic disk 24. The read channel 15 converts the data written to the magnetic disk 24 to a signal, and converts the signal read from the magnetic disk 24 to the data. The head IC 16 amplifies the signal written to the magnetic disk 24 and the signal read from the magnetic disk 24 by the read/write head 23. The MPU 17 controls operation of an entire magnetic disk device 1. The memory 18 is a volatile memory. The nonvolatile memory 19 stores a program to control the magnetic disk device. The servo controller 20 controls operation of the VCM 21 and of the SPM 22. The VCM 21 drives the read/write head 23. The SMP 22 rotation drives the magnetic disk 24. The read/write head 23 writes the signal as the data and reads the signal as the recorded data to and from the magnetic disk 24. The magnetic disk 24 is a storage medium for recording the data. The bus 25 is a transmission path of the data and the command among the host IF controller 11, the buffer controller 12, the format controller 14, the read channel 15, the head IC 16, the MPU 17, the memory 18, the nonvolatile memory 19 and the servo controller 20.

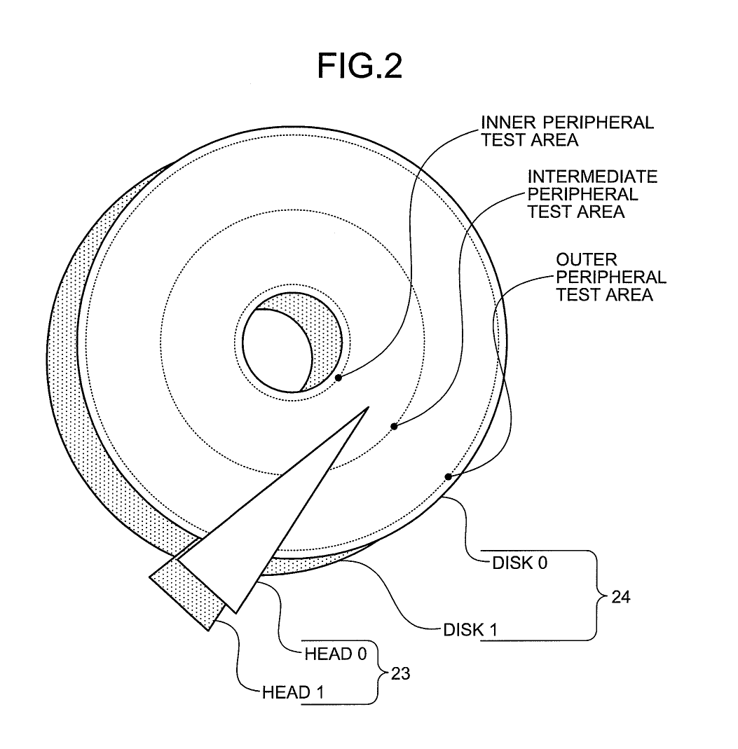

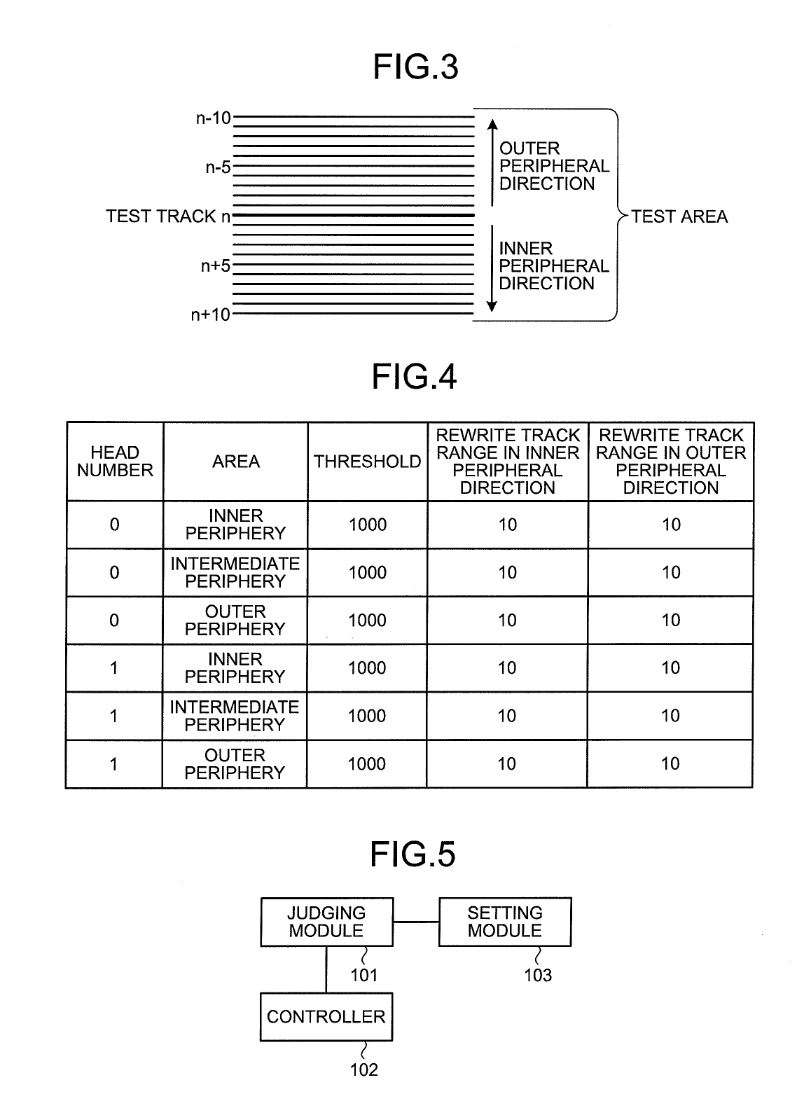

Next, test areas in the embodiment are described. The test areas are areas provided at a plurality of positions of the magnetic disk for performing a test to a side erase phenomenon. Each test area has a plurality of consecutive tracks. FIG. 2 is a view illustrating a plurality of test areas in the embodiment. FIG. 3 is a view illustrating the tracks in the test area.

As illustrated in FIG. 2, in the embodiment, the magnetic disk 24 comprises two disks, which are a disk 0 and a disk 1, and the test areas are provided on each of the disks. The read/write head 23 also comprises two heads, which are a head 0 for the disk 0 and a head 1 for the disk 1. Three test areas, which are an inner peripheral test area, an intermediate peripheral test area, and an outer peripheral test area, are provided to one disk. The inner peripheral test area is the test area located on an innermost side (innermost peripheral position) of the disk. The intermediate peripheral test area is the test area in which an arm of each of the heads is most parallel to a forward direction of the test track. The outer peripheral test area is the test area located on an outermost side (outermost peripheral position) of the disk. By providing at least these test areas on the disk, an effect by the side erase phenomenon may be examined with high accuracy. Meanwhile, the above-described number of test areas, number of disks and number of heads are no more than one example, and are not limited to them.

As illustrated in FIG. 3, each of the test areas comprises a test track n to which the signal is written for the test, 10 tracks in an inner peripheral direction, and 10 tracks in an outer peripheral direction from the test track n. In the embodiment, the 10 tracks in the inner peripheral direction are represented by positive numbers and the 10 tracks in the outer peripheral direction are represented by negative numbers based on the test track n. For example, a tenth track from the test track n in the outer peripheral direction is a track n−10. Meanwhile, the tracks other than the test track n in the test area only have to be the consecutive tracks comprising at least the track adjacent to the test track n in the inner peripheral direction and the outer peripheral direction. The number of tracks in the inner peripheral direction and the outer peripheral direction from the test track n in the test area is determined based on a worst value. The worst value is obtained by combination of the read/write head 23 and the magnetic disk 24 of the same type. For example, when a maximum number of the number of tracks in which the side erase phenomenon occurs in regard to the writing to one track is 12 in the combination of the same type, the number of tracks in the outer peripheral direction and the inner peripheral direction in the test area is 12.

The data is written to the test track n a plurality of times, and thereafter, the tracks other than the test track n in the test area are read. Predetermined data is written in advance to the tracks other than the test track n in the test area as test data, and this is read after the writing of the data to the test track n. Based on an error of the read data, the number of writing times to the test track n with which the side erase phenomenon occurs and the number of tracks in which the data is erased are determined.

Next, a threshold table is described. FIG. 4 is a view illustrating the threshold table in an initial state.

As illustrated in FIG. 4, the threshold table is the table in which a head number, an area, a threshold, a rewrite track range in the inner peripheral direction, and a rewrite track range in the outer peripheral direction, are associated with one another and managed. The head number indicates the head 0 or the head 1. The area indicates any of the inner peripheral test area, the intermediate peripheral test area, and the outer peripheral test area of the disk to which the signal is written and from which the signal is read by the head indicated by the head number. The threshold is the number of writing times to the test track n with which the side erase phenomenon occurs in the adjacent track. The rewrite track range in the inner peripheral direction is the number of tracks consecutive in the inner peripheral direction required to be rewritten in regard to the side erase phenomenon, which occurs by the signal writing to the test track n. The rewrite track range in the outer peripheral direction is the number of tracks consecutive in the outer peripheral direction required to be rewritten in regard to the side erase phenomenon, which occurs by the signal writing to the test track n. That is to say, the rewrite track range in the inner peripheral direction and the rewrite track range in the outer peripheral direction indicate a range of the effect of the side erase phenomenon, which occurs in regard to the writing to the test track n. FIG. 4 illustrates the threshold table in the initial state in which initial values are written to the threshold, the rewrite track range in the inner peripheral direction, and the rewrite track range in the outer peripheral direction. The initial values are the values based on the worst values measured in advance. Meanwhile, in the embodiment, although the threshold table is stored in a system area of the magnetic disk 24, the threshold table may be stored in the non-volatile memory 19.

Next, a functional configuration of the magnetic disk device according to the embodiment is described. FIG. 5 is a block diagram illustrating the functional configuration of the magnetic device according to the embodiment.

As illustrated in FIG. 5, the magnetic disk device 1 according to the embodiment comprises a judging module 101 (first judging module, second judging module, and third judging module), a controller 102 (writing module and reading module), a setting module 103 (first recording module, second recording module, and third recording module). The judging module 101 executes judgment in processing to be described later. The controller 102 controls the writing to the test track n and the reading from the tracks other than the test track n in the test area by the read/write head 23. The setting module 103 changes the values in the threshold table. Meanwhile, the modules are substantially realized by the MPU 17.

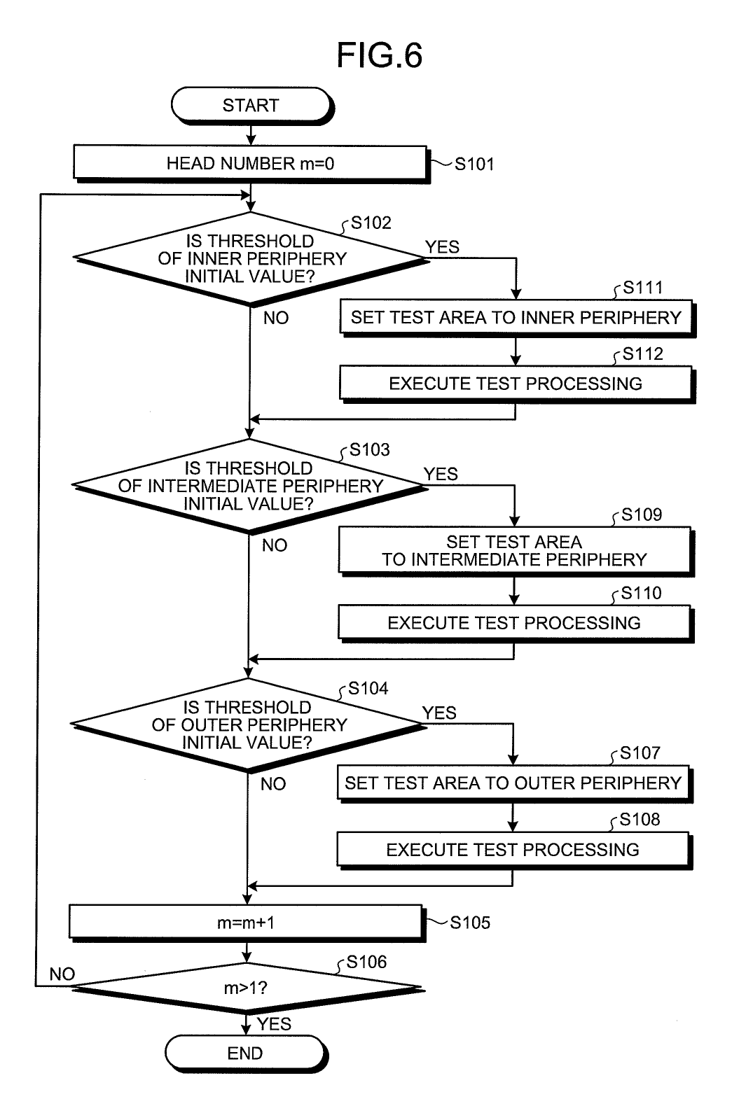

Next, set processing is described. The set processing is the processing to determine the head, which performs the test, and the test area. FIG. 6 is a flowchart illustrating the operation of the set processing.

First, the setting module 103 sets a variable m indicating the head number to 0 (S101). Next, the judging module 101 refers to the threshold table to judge whether the threshold of the inner peripheral test area in the disk corresponding to the head m is the initial value (S102).

When the threshold of the inner peripheral test area is not the initial value (NO at S102), the judging module 101 refers to the threshold table to judge whether the threshold of the intermediate peripheral test area in the disk corresponding to the head m is the initial value (S103).

When the threshold of the intermediate peripheral test area is not the initial value (NO at S103), the judging module 101 refers to the threshold table to judge whether the threshold of the outer peripheral test area in the disk corresponding to the head m is the initial value (S104).

When the threshold of the outer peripheral test area is not the initial value (NO at S104), the setting module 103 sets to a value obtained by adding 1 to m (S105). Next, the judging module 101 judges whether m is larger than 1 (S106).

When m is larger than 1 (S106), the judging module 101 terminates the set processing.

On the other hand, when m is not larger than 1 (No at S106), the judging module 101 judges whether the threshold of the inner peripheral test area in the disk corresponding to the head m is the initial value (S102).

At S104, when the threshold of the outer peripheral test area is the initial value (YES at S104), the setting module 103 sets the test area to the outer periphery (S107). Next, in the outer peripheral test area in the disk corresponding to the head m, test processing to be described later is executed (S108).

At S103, when the threshold of the intermediate peripheral test area is the initial value (YES at S103), the setting module 103 sets the test area to the intermediate periphery (S109). Next, the test processing is executed in the intermediate peripheral test area in the disk corresponding to the head m (S110).

At S102, when the threshold of the inner peripheral test area is the initial value (YES at S102), the setting module 103 sets the test area to the inner periphery (S111). Next, the test processing is executed in the inner peripheral test area in the disk corresponding to the head m (S112).

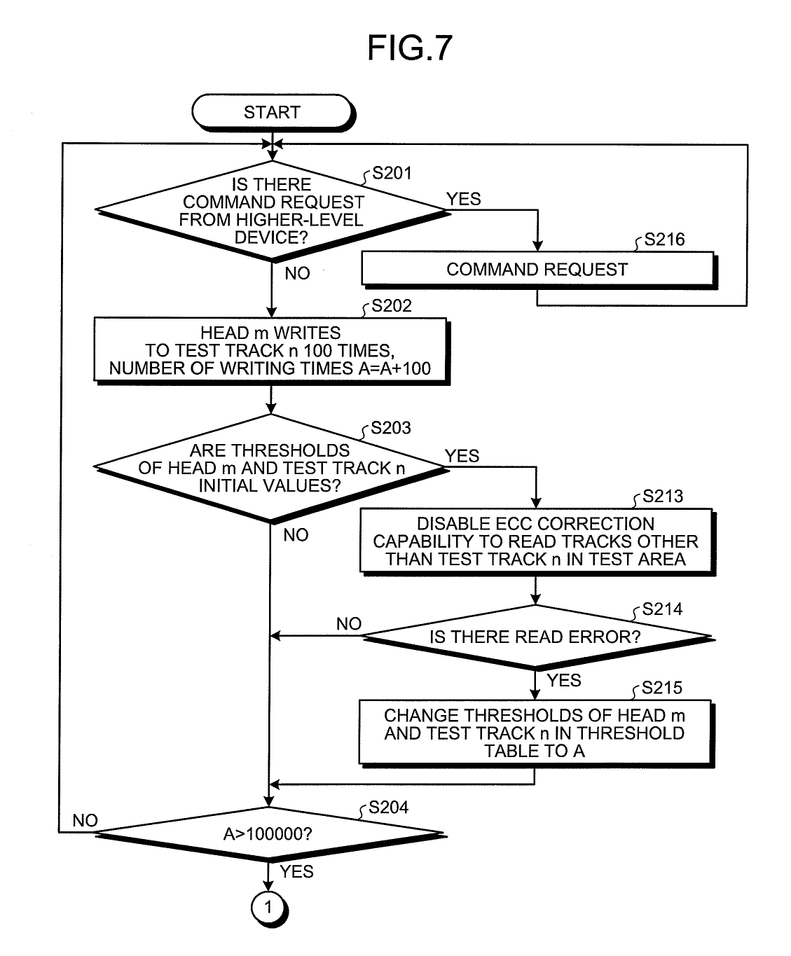

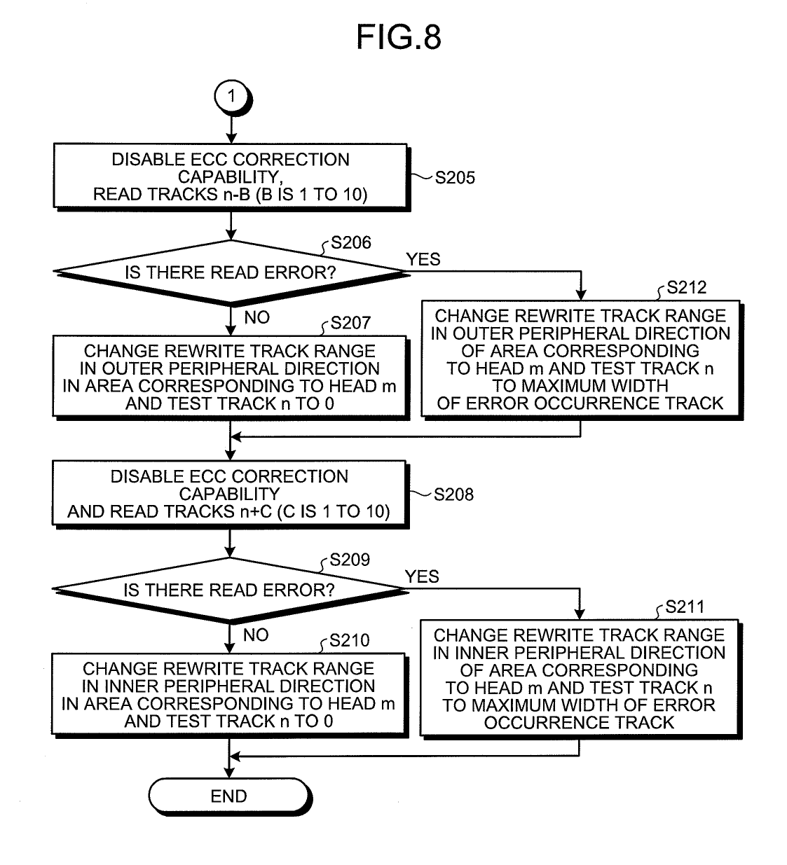

Next, the test processing is described. FIGS. 7 and 8 are flowcharts illustrating the test processing. Meanwhile, in the flowcharts, the head number and the test area are already set. In the flowcharts, an initial value of a variable A indicating the number of writing times is set to 0.

First, the judging module 101 judges whether there is a command request from the higher-level device 2 (S201).

When there is not the command request from the higher-level device 2 (NO at S201), the controller 102 instructs the head m to write the predetermined data 100 times to the test track n of the test area, and adds 100 to the variable A indicating the number of writing times (S202). Next, the judging module 101 judges whether the thresholds of the head m and the test track n in the threshold table are the initial values (S203).

When the thresholds are not the initial values (NO at S203), the judging module 101 judges whether the number of writing times A is larger than 100000 (S204).

When the number of writing times A is larger than 100000 (YES at S204), the controller 102 disables ECC correction capability and issues an instruction to read tracks n-B (B is 1 to 10) (S205). According to this, the data written to all the tracks located in the outer peripheral direction relative to the test track n in the test area is read. Next, the judging module 101 judges whether there is an error in the read data of the tracks n−1 to n−10 (S206).

When there is no error in the read data of the tracks n−1 to n−10 (NO at S206), the setting module 103 changes the rewrite track range in the outer peripheral direction in the test area corresponding to the head m and the test track n to 0 in the threshold table (S207). Next, the controller 102 disables the ECC correction capability and issues an instruction to read tracks n+C (C is 1 to 10) (S208). According to this, the data written to all the tracks located in the inner peripheral direction relative to the test track n in the test area is read. Next, the judging module 101 judges whether there is the error in the read data of the tracks n+1 to n+10 (S209).

When there is no error in the read data of the tracks n+1 to n+10 (NO at S209), the setting module 103 changes the rewrite track range in the inner peripheral direction of the test area corresponding to the head m and the test track n to 0 in the threshold table (S210) and terminates the processing.

On the other hand, when there is the error in the read data of the tracks n+1 to n+10 (YES at S209), the setting module 103 changes the rewrite track range in the inner peripheral direction of the test area corresponding to the head m and the test track n to a maximum width of an error track in the threshold table (S211). Specifically, the rewrite track range in the inner peripheral direction is set to a maximum value of B in the tracks located in the inner peripheral direction from which the error in the data is read. That is to say, the error track the farthest from the test track n in the inner peripheral direction is recorded.

At S206, when there is the error in the read data of the tracks n−1 to n−10 (YES at S206), the setting module 103 changes the rewrite track range in the outer peripheral direction of the test area corresponding to the head m and the test track n to the maximum width of the error track in the threshold table (S212). Specifically, the rewrite track range in the outer peripheral direction is set to a maximum value of C in the tracks located in the outer peripheral direction from which the error in the data is read. That is to say, the error track the farthest from the test track n in the outer peripheral direction is recorded.

At S204, when the number of writing times A is not larger than 100000 (NO at 5204), the judging module 101 judges again whether there is the command request from the higher-level device 2 (S201).

At S203, when the threshold is the initial value (YES at 5203), the controller 102 disables the ECC correction capability and reads the tracks other than the test track n in the test area (S213). Next, the judging module 101 judges whether there is the error in the test data read from the tracks other than the test track n in the test area (S214).

When there is the error in the test data (YES at 5214), the setting module 103 changes the threshold of the test area to which the head m and the test track n belong in the threshold table to A (S215). Next, the judging module 101 judges whether the number of writing times A is larger than 100000 (S204).

On the other hand, when there is no error in the test data (NO at S214), the judging module 101 judges whether the number of writing times A is larger than 100000 (S204).

At S201, when there is the command request from the higher-level device 2 (YES at S201), the controller 102 executes command processing based on the command request (S216).

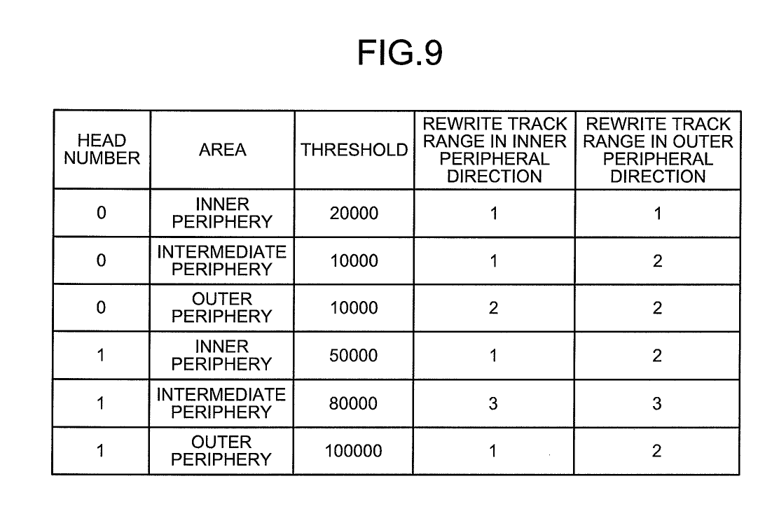

Meanwhile, in the above-described processing, although the ECC correction capability by ECC is disabled and the tracks other than the test track n in the test area are read, the ECC correction capability only has to be reduced than normal time. The normal time means the reading of the tracks other than the test area. According to this, it becomes easy to find the track in which the data is erased by the side erase phenomenon. Hereinafter, the threshold table in which the value is changed by the above-described processing is described. FIG. 9 is a view illustrating the threshold table after the test processing.

As illustrated in FIG. 9, by the test processing, the value is set for each test area of the disk corresponding to each head in the threshold table. The rewiring in regard to the side erase phenomenon is performed based on the threshold table. For example, suppose that the data is written to the track the nearest to the inner peripheral test area of the disk corresponding to the head 1 not less than 50000 times. In this case, the rewriting is performed to a total of three tracks, which are one track in the inner peripheral direction and two tracks in the outer peripheral direction from the track to which the data is written the times not less than the threshold. Areas on the disk may be divided into, for example, the inner peripheral area, the intermediate peripheral area, and the outer peripheral area, based on each of the test areas to associate with each of the test areas. In this case, for example, judgment of whether to rewrite to the track of the inner peripheral area is made based on a parameter of the threshold of the corresponding inner peripheral test area.

As described above, by examining the number of writing times with which the side erase phenomenon occurs (threshold) and a range in which the data is erased by the side erase phenomenon (rewrite track) for each of the head and the test area, deterioration of the performance due to the rewriting essentially unnecessary may be reduced. According to the above-described processing, even in an end user environment, the test may be performed in idle time, so that time of a test before shipping at the time of production of the magnetic disk device 1 may be reduced, and as a result, production efficiency may also be improved.

According to the aforementioned embodiment, an excess number of rewriting data for the side erase phenomenon can be reduced.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic disk device, comprising:
a magnetic disk comprising areas at a plurality of positions, the areas comprising a plurality of consecutive tracks;
a magnetic head configured to record data in the magnetic disk and to read the recorded data;
a writer configured to write data to a first track in at least one of the areas by the magnetic head;
a reader configured to read data of a second track in the at least one of the areas by using the magnetic head;
a first determining module configured to determining whether there is an error in the read data; and
a first recorder configured to associate the at least one of the areas and the number of writing the first data to the first track and to record the at least one of the areas and the number of writing the first data to the first track in a storage module, when the first determining module determines that there is the error in the data of the second track.

2. The magnetic disk device of claim 1, wherein the first recorder is configured to further associate the at least one of the areas, the number of writing the data to the first track and the magnetic head that writes the data to the first track, when the first determining module determines that there is the error in the data of the second track.

3. The magnetic disk device of claim 1, further comprising:
a second determining module configured to determine whether there is an error in data of a track in an outer peripheral direction of the magnetic disk relative to the first track in the at least one of areas read by the reader;
a second recorder configured to associate a track position of a track comprising the error among the tracks determined by the second determining module and being the farthest from the first track, the at least one of areas, and the magnetic head that writes the data to the first track, and to record the track position of the track comprising the error, the at least one of areas, and the magnetic head that writes the data to the first track, when the second determining module determines that there is the error in the data;
a third determining module configured to determining whether there is an error in data of a track in an inner peripheral direction of the magnetic disk relative to the first track in the at least one of areas read by the reader; and
a third recorder configured to associate a track position of a track comprising the error among the tracks determined by the third determining module and being the farthest from the first track, the at least one of areas, and the magnetic head that writes the data to the first track, and to record the track position of the track among the tracks determined by the third determining module to comprise the error and being the farthest from the first track, the at least one of areas, and the magnetic head that writes the data to the first track in the storage module, when the third determining module determines that there is the error in the data.

4. The magnetic disk device of claim 1, wherein the positions comprise an innermost peripheral position of the magnetic disk, an outermost peripheral position of the magnetic disk, and a position at which an arm of the magnetic head is substantially parallel to a forward direction of the track in the magnetic device.

5. The magnetic disk device of claim 1, wherein the reader is configured to reduce error correction capability of when the data of the second track is read by an error-correction code, with respect to the error correction capability of when data of a track of an area other than the areas is read.

6. The magnetic disk device of claim 1, wherein the writer is configured to write the data to the first track by the magnetic head when there is no command from a host of the magnetic disk device.

7. The magnetic disk device of claim 1, wherein the storage module is a system area in the magnetic disk.

8. A control device of a magnetic disk device for recording data in a magnetic disk by a magnetic head, the magnetic disk comprising areas at a plurality of positions, the areas comprising a plurality of consecutive tracks, the control device comprising:
a writer configured to write data to a first track in at least one of areas by the magnetic head;
a reader configured to read data of a second track in the at least one of the areas by using the magnetic head;
a first determining module configured to determine whether there is an error in the read data; and
a first recorder configured to associate the at least one of the areas and the number of writing the data to the first track and to record the at least one of the areas and the number of writing the data to the first track in a storage module, when the first determining module determines that there is the error in the data of the second track.

9. The control device of claim 8, wherein the first recorder is configured to further associate the at least one of the areas, the number of writing the data to the first track, and the magnetic head that writes the data to the first track when the first determining module determines that there is the error in the data of the second track.

10. The control device of claim 8, further comprising:
a second determining module configured to determine whether there is an error in data of a track in an outer peripheral direction of the magnetic disk relative to the first track in the at least one of areas read by the reader;
a second recorder configured to associate a track position of a track comprising the error among the tracks determined by the second determining module and being the farthest from the first track, the at least one of areas, and the magnetic head that writes the data to the first track and to record the track position of the track comprising the error among the tracks determined by the second determining module and being the farthest from the first track, the at least one of areas, and the magnetic head that writes the data to the first track in the storage module, when the second determining module determines that there is the error in the data;
a third determining module configured to determine whether there is an error in data of a track in an inner peripheral direction of the magnetic disk relative to the first track in the at least one of areas read by the reader; and
a third recorder configured to associate a track position of a track comprising the error among the tracks determined by the third determining module and being the farthest from the first track, the at least one of areas, and the magnetic head that writes the data to the first track, and to record the track position of the track comprising the error among the tracks determined by the third determining module and being the farthest from the first track, the at least one of areas, and the magnetic head that writes the data to the first track in the storage module, when the third determining module determines that there is the error in the data.

11. The control device of claim 8, wherein the positions comprise an innermost peripheral position of the magnetic disk, an outermost peripheral position of the magnetic disk, and a position at which an arm of the magnetic head is substantially parallel to a forward direction of the track in the magnetic device.

12. The control device of claim 8, wherein the reader is configured to reduce error correction capability of when the second data is read by an error-correction code, with respect to the error correction capability of when data of a track of an area other than the areas is read.

13. The control device of claim 8, wherein the writer is configured to write the data to the first track by the magnetic head when there is no command from a host of the magnetic disk device.

14. The control device of claim 8, wherein the storage module is a system area in the magnetic disk.

15. A control method of a magnetic disk device for recording data in a magnetic disk comprising areas at a plurality of positions by a magnetic head, the areas comprising a plurality of consecutive tracks, the control method comprising:
writing data to a first track in at least one of areas by the magnetic head;
reading data of a second track in the at least one of the areas by using the magnetic head;
first determining whether there is an error in the read data; and
first associating the at least one of the areas and the number of writing the data to the first track when it is determined that there is the error in the data of the second track; and
first recording the at least one of the areas and the number of writing the data to the first track in a storage module when it is determined that there is the error in the data of the second track.

16. The control method of claim 15 further comprising:
associating the at least one of the areas, the number of writing the data to the first track, and the magnetic head that writes the data to the first track, when it is determined that there is the error in the data of the second track.

17. The control method of claim 15, further comprising:
second determining whether there is an error in data of a track in an outer peripheral direction of the magnetic disk relative to the first track in the at least one of areas read;
second associating a track position of a track comprising the error among the tracks determined in the second determining and being the farthest from the first track, the at least one of areas, and the magnetic head that writes the data to the first track, when it is determined in the second determining that there is the error in the data;
second recording the track position of the track comprising the error among the tracks determined in the second determining and being the farthest from the first track, the at least one of areas, and the magnetic head that writes the data to the first track in the storage module, when it is determined that there is the error in the data;
third determining whether there is an error in data of a track in an inner peripheral direction of the magnetic disk relative to the first track in the at least one of areas read; and
third associating a track position of a track comprising the error among the tracks determined in the third determining and being the farthest from the first track, the at least one of areas, and the magnetic head that writes the data to the first track, when it is determined in the third determining that there is the error in the data; and
third recording of the track position of the track comprising the error among the tracks determined in the third determining and being the farthest from the first track, the at least one of areas, and the magnetic head that writes the data to the first track in the storage module when it is determined in the third determining that there is the error in the data.

18. The control method of claim 15, wherein the positions comprise an innermost peripheral position of the magnetic disk, an outermost peripheral position of the magnetic disk, and a position at which an arm of the magnetic head is substantially parallel to a forward direction of the track in the magnetic device.

19. The control method of claim 15, further comprising:
reducing error correction capability of when the data of the second track is read by an error-correction code, with respect to the error correction capability of when data of a track of an area other than the areas is read.

20. The control method of claim 15, further comprising:
writing the data to the first track by the magnetic head when there is no command from a host of the magnetic disk device.
